(19) United States
(12) Patent Application Publication
(10) Pub. No.: US 2022/0188363 A1
(43) Pub. Date: Jun. 16, 2022

(54) INFORMATION PROCESSING APPARATUS, INFORMATION PROCESSING METHOD, AND PROGRAM

(71) Applicant: SONY GROUP CORPORATION, Tokyo (JP)

(72) Inventors: Mitsuhiro MIYAZAKI, Kanagawa (JP); Shogo KIMURA, Tokyo (JP)

(73) Assignee: SONY GROUP CORPORATION, Tokyo (JP)

(21) Appl. No.: 17/441,438

(22) PCT Filed: Mar. 17, 2020
(86) PCT No.: PCT/JP2020/011743

§ 371 Date: Sep. 21, 2021

(30) Foreign Application Priority Data
Mar. 28, 2019 (JP) 2019-062944

(51) Int. Cl. G06F 16/9032; G06F 16/9035; G10L 15/22; G06F 16/901

(52) U.S. Cl. CPC G06F 16/90332; G06F 16/901; G10L 15/22; G06F 16/9035

(57) ABSTRACT

An information processing apparatus includes a recommendation unit 260 that switches between a first process of presenting at least one of first information retrieved based on a condition acquired through a voice interaction with a user or second information selected based on the user preference and a second process of generating a question relating to a condition for the retrieval and presenting the question to the user based on a condition rarity that is an index value relating to a percentage of the number of information matching the condition to a total number of information to be retrieved.

### TECHNICAL FIELD

The present technology relates to an information processing apparatus, an information processing method, and a program for retrieving content based on a condition specified by a user and selecting content based on a user preference.

### BACKGROUND ART

In recent years, there has been known a voice interactive assistant service that retrieves information of content that meets conditions specified by a user among content relating to various information such as shops, restaurants, events, and enjoyment spots that exist on the Web, and responds.

However, although there is no problem when an appropriate condition is given by the user, a retrieval result as desired by the user is not necessarily obtained depending on a way the condition is expressed and the selection thereof. Therefore, Patent Literature 1 discloses a technology that, when retrieving a point database according to a voice recognition result, a condition for narrowing down candidates is sent to a user through a What type question if the number of candidates is larger than a predetermined value, and a condition is extracted from a user's answer to the question to narrow down the candidates.

### CITATION LIST

### Patent Literature

Patent Literature 1: Japanese Patent

Application Laid-open No. 2006-178898

### DISCLOSURE OF INVENTION

### Technical Problem

However, an information retrieval based on the condition given by the user still had many insufficient points, and as a result, there was a scene in which a large burden was imposed on the user without obtaining the retrieval result as desired by the user.

It is an object of the present technology to provide an information processing apparatus, an information processing method, and a program that can improve a convenience of the user who uses the information retrieval by a voice interaction and improve an accuracy of the information retrieval.

### Solution to Problem

In order to solve the above-mentioned problems, an information processing apparatus according to an embodiment of the present technology includes a control unit that switches between a first process of presenting at least one of first information retrieved based on a condition acquired through a voice interaction with a user or second information selected based on the user preference and a second process of generating a question relating to a condition for the retrieval and presenting the question to the user based on a condition rarity that is an index value relating to a percentage of the number of information matching the condition to a total number of information to be retrieved.

According to the information processing apparatus of one embodiment of the present technology, by switching between the first process and the second process in a timely manner based on the condition rarity, when the condition rarity is low, that is, when narrowing down of an information retrieval result is insufficient, it is possible to explicitly prompt the user to add a new condition by generating a question relating to the condition for retrieval and presenting it to the user.

The second process may generate an option mode question.

This allows the user to respond quickly to condition with a correct expression. As a result, both a speed and an accuracy of the information retrieval can be improved.

The control unit may further switch between the first process and the second process based on a degree of an interaction progress that is an index value relating to at least one of the number of times and the time of the voice interaction.

That is, by presenting the option mode question to the user when the interaction progress is high, the information retrieval based on the condition with the correct expression becomes possible, and a speed improvement and an accuracy improvement of the information retrieval can be expected in addition to a burden reduction of the user.

The control unit may further switch between the first process and the second process based on a user reaction clarity at the time of a voice interaction.

That is, when the user reaction clarity is low, it is possible to avoid the information retrieval based on an unclear condition by presenting the option mode question to the user, and it is possible to improve an efficiency of the information retrieval.

The control unit determines the user reaction clarity based on a direction of a user's face or utterance content at the time of the voice interaction.

When the user's face is not directed toward a front, or when the utterance content is unclear, it is determined that the user reaction clarity is low, and the second process of generating a question relating to the condition for retrieval and presenting it to the user is executed, thereby avoiding information retrieval based on the unclear condition.

The first process may select the information to be presented from the first information and the second information based on the degree of the interaction progress and the user reaction clarity.

For example, when the user reaction clarity is low, there is a high likelihood that the condition specified by the user in the voice interaction is inappropriate. In this case, by presenting the user with the second information corresponding to the user preference, it is possible to avoid presenting the user with only information that is not desired by the user.

Also, even when the interaction progress is high, by presenting the user with the second information corresponding to the user preference, it is possible to avoid the user from presenting from the information not desired by the user.

The control unit may probabilistically select a question category to be used for the option mode question among a plurality of question categories for classifying types of question categories corresponding to a priority determined among the plurality of question categories.

The control unit may probabilistically select the number of options in the option mode question according to the priority determined corresponding to the number of answers from the user by the voice interaction.

The control unit may select content of an option in the option mode question based on a frequency of use in an utterance or an answer to the question.

The control unit may select the content of the option in the option mode question based on a date and time condition.

An information processing method according to another embodiment of the present technology is characterized in that a control unit switches between a first process of presenting at least one of first information retrieved based on a condition acquired through a voice interaction with a user or second information selected based on a user preference, and a second process of generating a question relating to a condition for the retrieval and presenting the question to the user, based on a condition rarity that is an index value relating to a percentage of the number of information matching the condition to a total number of information to be retrieved.

Furthermore, a program according to another embodiment of the present technology executed by a control unit switches between a first process of presenting at least one of first information retrieved based on a condition acquired through a voice interaction with a user or second information selected based on a user preference, and a second process of generating a question relating to a condition for the retrieval and presenting the question to the user, based on a condition rarity that is an index value relating to a percentage of the number of information matching the condition to a total number of information to be retrieved.

### Advantageous Effects of Invention

As described above, according to the present technology, it is possible to solve various problems in retrieving content based on a condition specified by a user and selecting content based on the user preference.

### BRIEF DESCRIPTION OF DRAWINGS

FIG. 1 is a diagram showing an example of a page of an information retrieval/recommendation result generated by a service with respect to a condition given by a user.

FIG. 2 is a block diagram showing a configuration example of a system including an information processing apparatus according to the present embodiment.

FIG. 3 is a block diagram showing a configuration example of the function of the information processing terminal 10 according to the present embodiment.

FIG. 4 is a block diagram showing an example of a functional configuration of an information processing server 20 according to the present embodiment.

FIG. 5 is a block diagram showing an example of a functional configuration of a presentation control unit 230 according to the present embodiment.

FIG. 6 shows a structure of metadata.

FIG. 7 also shows the structure of metadata.

FIG. 8 shows an exemplary bloadcategory.

FIG. 9 shows an exemplary stylecategory.

FIG. 10 shows an exemplary nudgecategory.

FIG. 11 shows a sample servicecategory.

FIG. 12 shows an example of a data-structure of a user reaction (feedback) that is a user history.

FIG. 13 is a flowchart illustrating a process flow from metadata analysis by the information processing server 20 to determination of a recommendation result.

FIG. 14 is a flowchart illustrating an overall flow of content retrieval by a voice interaction.

FIG. 15 is a flowchart of a question mode process.

FIG. 16 is a diagram showing an example of a rule for determining a question category.

FIG. 17 is a diagram for explaining a roulette selection method of the question category group.

FIG. 18 is a diagram showing an example of a rule for determining the number of question options.

FIG. 19 is a graph showing selection probabilities distributions for values of answers (n) among roulette selection patterns of listSize=3, 2, 1, 0.

FIG. 20 is a diagram showing a part of a rule for determining of content of the question options.

FIG. 21 is a diagram showing a rule for determining a question sentence.

FIG. 22 is a diagram showing an example of a question sentence template table for each question ID.

FIG. 23 is set as the content of the question options.

FIG. 24 is a flowchart of a proposed mode process.

FIG. 25 is a block diagram showing an example of the hardware configuration of the information processing terminal 10 and the information processing server 20 according to the embodiment of the present disclosure.

### MODE(S) FOR CARRYING OUT THE INVENTION

Hereinafter, favorable embodiments of the present disclosure will be described in detail with reference to the accompanying drawings.

### 1 Embodiment

[1-1. Description of Outline]

First, the overview of an embodiment of the present technology will be described.

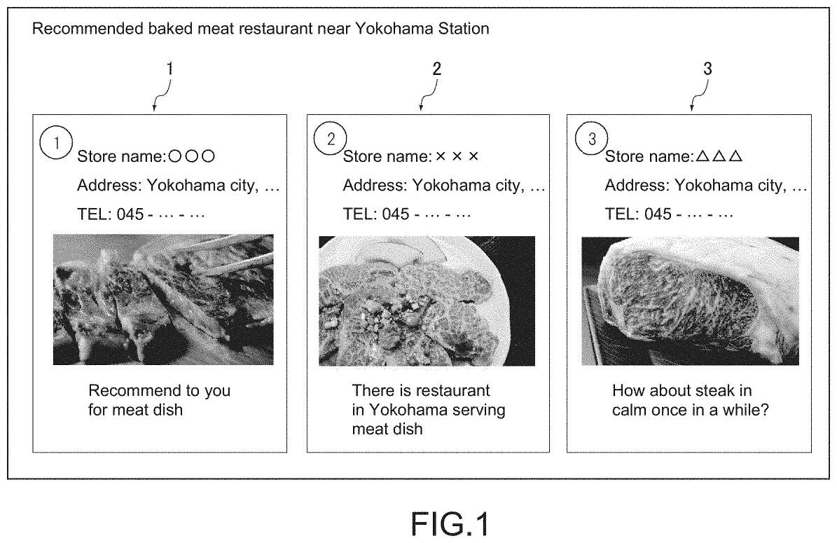

FIG. 1 is a diagram showing an example of a page of an information retrieval and a recommendation result generated by a service with respect to a condition of a “baked meat restaurant near Yokohama Station” given by a user. In the page of the information retrieval and the recommendation result, information pieces 1, 2, and 3 of three pieces of content (baked meat restaurant) satisfying the above-mentioned condition are present. The information pieces 1, 2, and 3 of the content each include, for example, a store name, an address, a telephone number, a photo, a recommendation comment, a URL of a home page, and the like for each spot.

However, when a clear condition is given by the user, there is no problem. However, a condition of an unclear expression may be specified or a condition that is not suitable for narrowing down a retrieval result sufficiently may be specified by some user. So a retrieval result with high user satisfaction may not be obtained, and, as a result, it may be necessary to repeat to specify the condition many times.

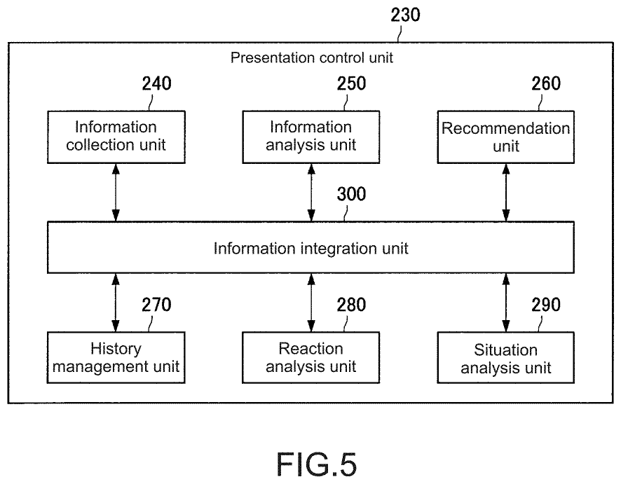

Therefore, the information processing apparatus according to a first embodiment of the present technology includes a recommendation unit 260 (FIG. 5) for prompting the user to specify the clear condition by presenting an option mode question, for example, “Which do you like OO, XX, and ΔΔ?” to the user when an information retrieval result cannot be sufficiently narrowed down with respect to the condition specified by the user.

In the present technology, a “condition rarity” is used as an index for evaluating whether or not the retrieval result is sufficiently narrowed down. The condition rarity is an index value relating to a percentage of the number of information matching the condition to a total number of information to be retrieved. The condition rarity is defined, for example, as a rarity=1−hit/total where “total” is the number of whole items present or the number of items hit by a system retrieval based on an initial condition and “hit” is the number of items hit by a retrieval based on the condition specified by the user. When a value of the condition rarity is equal to or more than a threshold value, it is determined that the narrowing of the retrieval result is sufficient, and when the value of the condition rarity is less than the threshold value, it is determined that the narrowing of the retrieval result is insufficient.

The information processing apparatus according to the first embodiment of the present technology has two modes in a voice interaction. One is a “proposal mode” which presents at least one of the first information according to a condition acquired through a voice interaction with the user or second information according to a user preference, and the other is a “question mode” which generates a question relating to the condition for retrieval and presents it to the user.

The recommendation unit 260 switches between the proposal mode and the question mode based on the condition rarity. More specifically, the recommendation unit 260 switches to the proposal mode when the condition rarity is equal to or greater than the threshold value. Alternatively, even if the condition rarity is less than the threshold value, the recommendation unit 260 switches to the proposal mode in a case where either one of a degree of an interaction progress or a degree of a user reaction clarity is equal to or more than each threshold value. In addition, the recommendation unit 260 may switch to the question mode when the condition rarity is less than the threshold value. Alternatively, the recommendation unit 260 may switch to the question mode if a degree of a voice interaction progress and the degree of the user reaction clarity are less than the respective threshold values even if the condition rarity is equal to or greater than the threshold value.

As a result, the information processing apparatus according to the first embodiment of the present technology can provide the user with the information retrieval and the recommendation result having a high degree of user satisfaction.

The outline of the present embodiment has been described above. Hereinafter, the information processing apparatus according to the present embodiment will be described in more detail.

[1-2. Configuration Example of System]

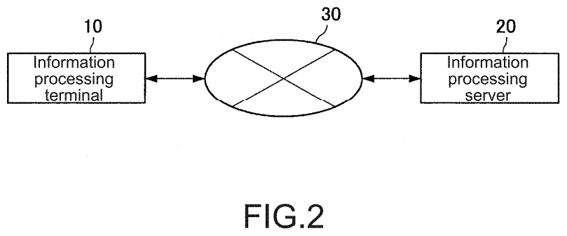

FIG. 2 is a block diagram showing a configuration example of a system including the information processing apparatus according to the present embodiment.

As shown in FIG. 2, the system according to the present embodiment includes an information processing terminal 10 and an information processing server 20. The information processing terminal 10 and the information processing server 20 are connected through a network 30 so as to communicate with each other.

The information processing terminal 10 is a device capable of presenting the information retrieval and the recommendation result supplied by the information processing server 20, presenting a question supplied by the information processing server 20, and transmitting an answer to the question to the information processing server 20 through the voice interaction with the user. The information processing terminal 10 includes various detectors for detecting situations of the user and a surrounding environment, and can transmit various kinds of detection data relating to a user situation and a user reaction to the information processing server 20 through the network 30.

The information processing server 20 is a device for retrieving information, making a recommendation, generating a question to the user relating to the condition, and the like based on the condition given from the user of the information processing terminal 10 and preference information of the user. In the present embodiment, the information processing apparatus in the claims corresponds to the “information processing server 20”.

The network 30 is a network that connects the information processing terminal 10 and the information processing server 20. The network 30 may be a public network such as the Internet, a telephone network, and a satellite communications network, a variety of the LAN (Local-Area Network) and the WAN (Wide-Area Network) including the Ethernet, or the like. The network 30 may also be a dedicated line network such as the IP-VPN (Internet Protocol-Virtual Private Network) and may include a wireless communication network such as the Wi-Fi (registered trademark) and the Bluetooth (registered trademark).

[1-3. Configuration Example of Information Processing Terminal 10]

Next, a function of the information processing terminal 10 according to the present embodiment will be described in detail.

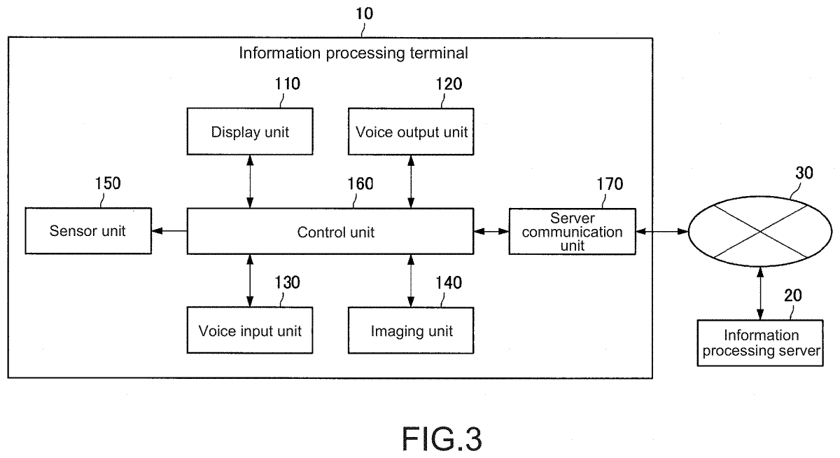

FIG. 3 is a block diagram showing a configuration example of the function of the information processing terminal 10 according to the present embodiment. As shown in FIG. 3, the information processing terminal 10 includes a display unit 110, a voice output unit 120, a voice input unit 130, an imaging unit 140, a sensor unit 150, a control unit 160, and a server communication unit 170.

The display unit 110 has a function of outputting visual information such as an image and text. The display unit 110 displays, for example, a retrieval result of an item, a recommendation result, and a text or an image relating to a question based on a control of the information processing server 20.

The display unit 110 includes a display device for presenting visual information. The display devices include, for example, a liquid crystal display (LCD: Liquid Crystal Display) devices, an OLED (Organic Light Emitting Diode) device, a touch panel, and the like. The display unit 110 according to the present embodiment may output the visual information by a projection function.

The voice output unit 120 outputs a voice for the voice interaction. The voice output unit 120 includes a voice output device such as a speaker and an amplifier.

The voice input unit 130 collects a user utterance for the voice interaction, a sound around the information processing terminal 10, and the like. The voice input unit 130 includes a microphone for collecting sound information.

The imaging unit 140 has a function of capturing an image of the surrounding environment of the user or the information processing terminal 10 and generating a still image or a moving image. The imaging unit 140 includes an image pickup device such as a CMOS (Complementary Metal Oxide Semiconductor) image sensor and a CCD (Charged-Coupled Devices) image sensor for capturing an image.

The sensor unit 150 has a function of detecting presence or absence of the user, a direction of the face, a facial expression of the user, and the surrounding environment of the information processing terminal 10. The sensor unit 150 includes, for example, an optical sensor including an infrared sensor, an acceleration sensor, a gyro sensor, a geomagnetic sensor, a thermal sensor, a vibrating sensor, a GNSS (Global Navigation Satellite System) signal receiving device.

The control unit 160 performs arithmetic processes such as a control of each block provided in the information processing terminal 10, generation of a display signal to be displayed on the display unit 110, generation of a voice signal for driving the voice output unit 120, digitalization of the voice collected by the voice input unit 130, digitalization of the image obtained by the imaging unit 140, and digitalization of the detection signal of the sensor unit 150. The control unit 160 may have a function of compressing and encoding digitalized voice, video, and sensor information in order to increase a speed of communication.

The server communication unit 170 has a function of performing information communication with the information processing server 20 through the network 30.

Incidentally, the information processing terminal 10 may be, for example, a voice interactive agent terminal, a personal computer having a voice interactive agent function, a mobile phone, a smartphone, a tablet terminal, and a wearable terminal having the voice interactive agent function, various home appliances, a fixed type or autonomous mobile type dedicated device.

A functional configuration example of the information processing terminal 10 according to the present embodiment has been described above. Note that the functional configuration of the information processing terminal 10 described with reference to FIG. 3 is merely an example, and is not limited to the above configuration. For example, the information processing terminal 10 does not necessarily have all of the configurations shown in FIG. 3. In addition, the control unit 160 of the information processing terminal 10 may have a function equivalent to that of a presentation control unit 230 of the information processing server 20, which will be described later. In this case, the information processing terminal 10 corresponds to the “information processing apparatus” in the claims according to the present technology.

[1-4. Configuration Example of Information Processing Server 20]

Next, a functional configuration example of the information processing server 20 according to the present embodiment will be described in detail.

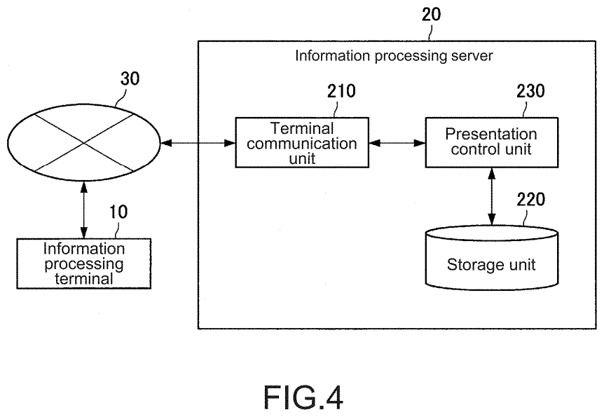

FIG. 4 is a block diagram showing the functional configuration example of the information processing server 20 according to the present embodiment. As shown in FIG. 4, the information processing server 20 according to the present embodiment includes a terminal communication unit 210, a storage unit 220, and a presentation control unit 230.

The terminal communication unit 210 has a function of performing the information communication with the information processing terminal 10 through the network 30.

The storage unit 220 includes a ROM (Read Only Memory) for storing a programs, an arithmetic parameter, and the like used for processing the presentation control unit 230, and a RAM (Random-Access Memory) for temporarily storing data such as a parameter that changes, as appropriate.

The presentation control unit 230 controls generation and presentation of the information retrieval and the recommendation result for the user of the information processing terminal 10, and also generation and presentation of the question relating to the condition for the information retrieval. In addition, the presentation control unit 230 analyzes the user situation and the user reaction based on the various types of detection data acquired from the information processing terminal 10, calculates the degree of the interaction progress and the degree of the user reaction clarity based on the results of these analyses, calculates the condition rarity, and controls switching between the proposal mode and the question mode based on the condition rarity, the degree of the interaction progress, and the degree of the user reaction clarity.

In this specification, the information to be retrieved and recommendation refers to respective shops, restaurants, services, events, entertainment spots, and the like whose existence or the like is disclosed through a web page or the like. For example, in the restaurants, stores such as “Yokohama store for Japanese food OO”, “Yokohama XX Chinese” and “Yokohama store for Western food ΔΔ” are retrieved and recommended by the present system.

[1-5. Configuration Example of the Presentation Control Unit 230]

Next, the configuration of the presentation control unit 230 in the information processing server 20 will be described in detail.

FIG. 5 is a block diagram showing a functional configuration example of the presentation control unit 230 according to the present embodiment. As shown in FIG. 5, the presentation control unit 230 includes an information collection unit 240, an information analysis unit 250, a recommendation unit 260, a user history management unit 270, a reaction analysis unit 280, a situation analysis unit 290, and an information integration unit 300.

(Information Collection Unit 240)

For example, the information collection unit 240 collects metadata of individual content by markup analysis, syntax analysis, or the like from content information such as a web page. “Content metadata” refers to data relating to the content, such as, for example, a name (store name), a location, a category, a telephone number, a budget, evaluations, reviews, etc. of the content such as a restaurant.

(Information Analysis Unit 250)

The information analysis unit 250 analyzes the metadata of the content collected by the information collection unit 240 to generate matching data for information recommendation. More specifically, the information analysis unit 250 may obtain a vector (content profile) having a score for each attribute value of the metadata as the matching data (for example, Japanese Patent Laid-Open No. 2005-176404).

(Metadata Structure)

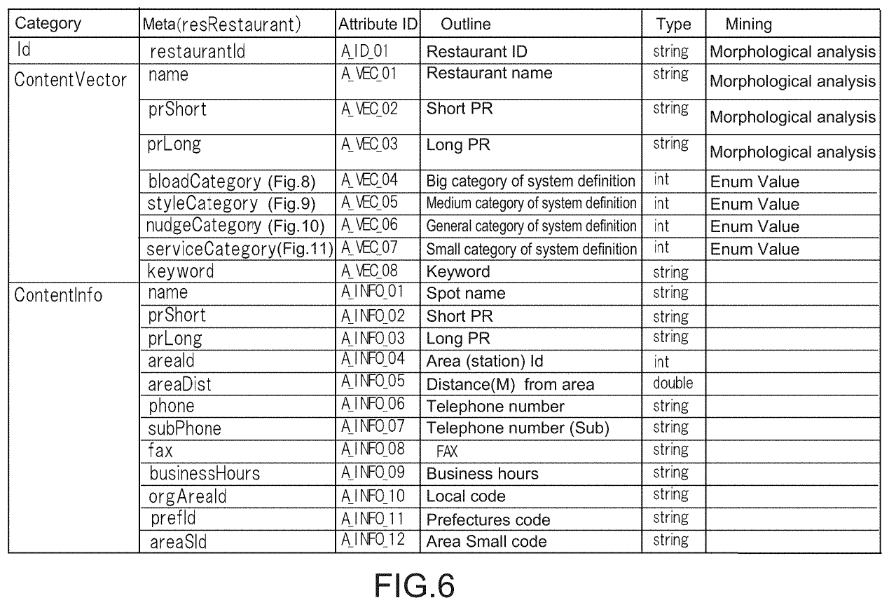

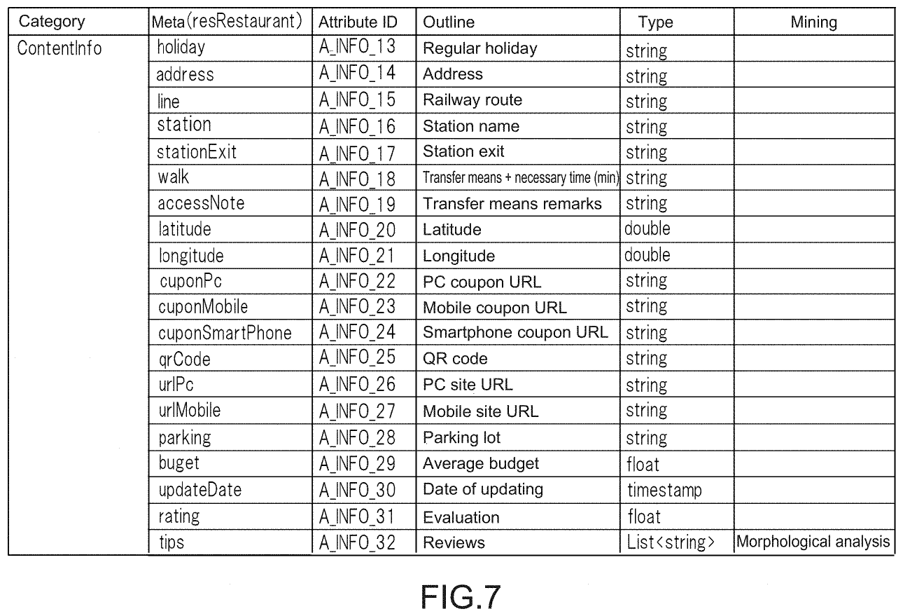

FIGS. 6 and 7 show the structures of the metadata.

The present example is directed to the content of the restaurant.

The metadata includes “Id”, “ContentVector”, and “ContentInfo”.

The “Id” is information that uniquely identifies target content. In this embodiment, “restaurantId” assigned to the restaurant is registered as a value of the “Id”.

The “ContentVector” is data used to calculate similarity between the content and the content and a relationship between the content and the user preference information. The “ContentVector” includes, for example, a name of the content (name), a PR description of the content (prShort, prLong), a system definition of the content, and so on. The system definition of the content include a large category “bloadcategory”, a medium category “stylecategory”, a general category “nudgecategory”, and a small category “servicecategory”.

The ContentInfo includes detailed information such as the location, a telephone number, business hours, an address, a price, latitude and longitude, URL of homepage, the evaluations, the reviews, and the like of the content (restaurants).

Incidentally, a distinction between the ContentVector and the ContentInfo is merely exemplary. The ContentVector and the ContentInfo may be partially overlapped, or may be defined as appropriate corresponding to the application. In addition, a string type text is morphologically analyzed and represented as a vector of a keyword (keyword, frequency).

In clustering for the reviews or an introductory sentence, a PLSA (Probabilistic Latent Semantic-Analysis or an LDA (Latent Dirichlet-Allocation) widely used in a textual classification as a technique of a potential topic model may be used. For more information about the PLSA, reference is made to Non-Patent Literature 1: Thomas Hofmann, “Probabilistic latent semantic indexing”, 1999, Proceedings of the 22nd annual international ACM SIGIR conference ON Research and development in information retrieval. For more information about the LDAs, reference is made to Non-Patent Literature 2: David M. Blei, Andrew Y. Ng, and Michael I. Jordan, “Latent Dirichlet Allocation”, 2003, Journal of Machine Learning Research, Volume 3.

In the PLSA, for example, an occurrence probability p(w|d) of words w in the introductory sentence d is expressed by the following equation using a potential topic z.

p(w|d)=Σp(w|z)p(z|d)

That is, by considering the potential topic z as a potential topic in which the introductory sentence and the words occur, it is possible to decompose the occurrence probability of the words in the introductory sentence into a “word occurrence probability for each potential topic” and a “topic attribution probability of the introductory sentence”. If the number of dimension of the topic z is 5, the attribution probability of the topic for an introduction of a certain spot is expressed as {0.4, 0.1, 0.7, 0.2, 0.5}, which results in the clustering.

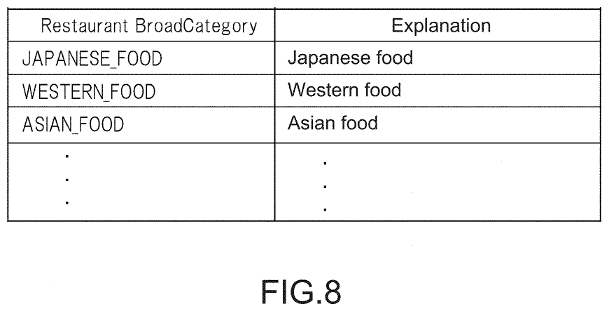

FIG. 8 shows an exemplary bloadcategory.

The bloadcategory is the large category to which the content belongs. The large category of the restaurants include, for example, “Japanese food”, “Western food”, and “Asian food”.

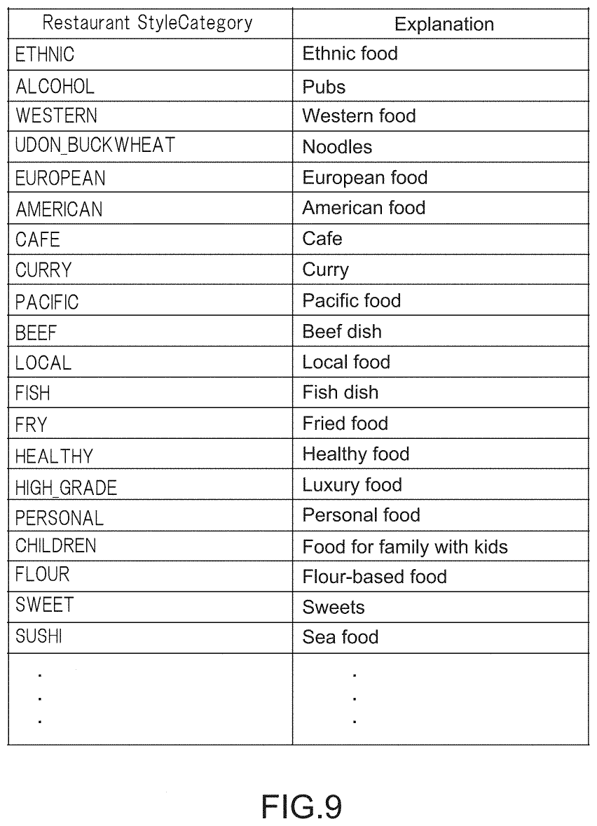

FIG. 9 shows an exemplary stylecategory.

The stylecategory is the medium category to which the content belongs, and is a category in which, for example, foods are more finely classified according to the styles of foods such as “ethnic food”, “pub”, “noodle”, “curry”, and the like.

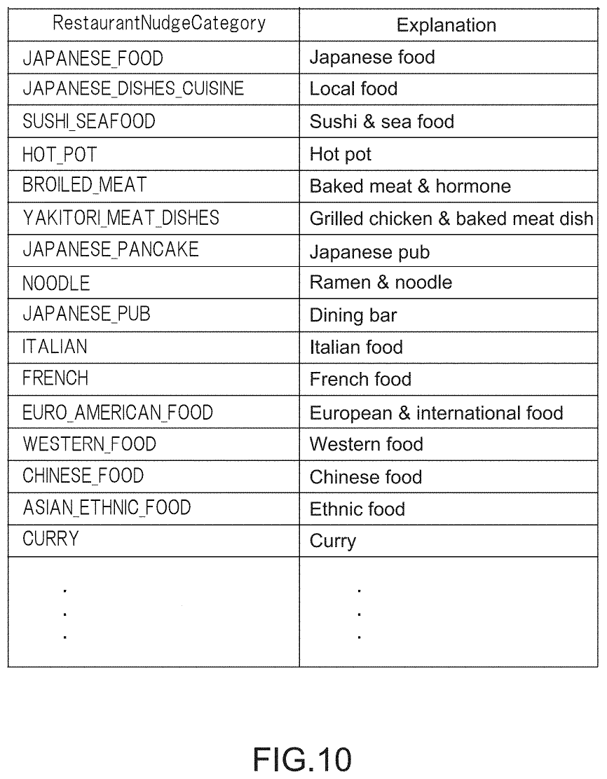

FIG. 10 shows an exemplary nudgecategory.

The nudgecategory is a generically classified category of the items (restaurants).

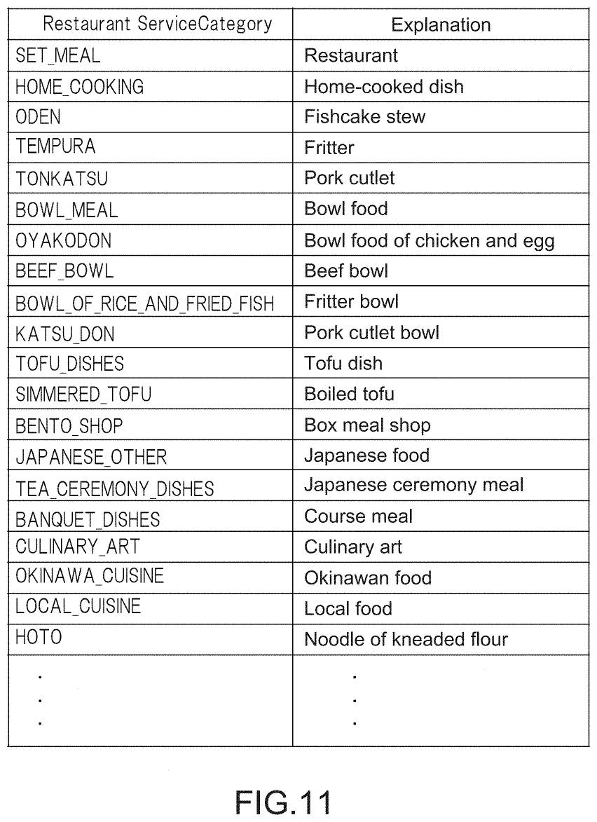

FIG. 11 shows an exemplary servicecategory.

The servicecategory is a category in which the items are finely classified according to specific types of foods.

The above is the description of the information analysis unit 250 and the metadata obtained by the information analysis unit 250.

(Recommendation Unit 260)

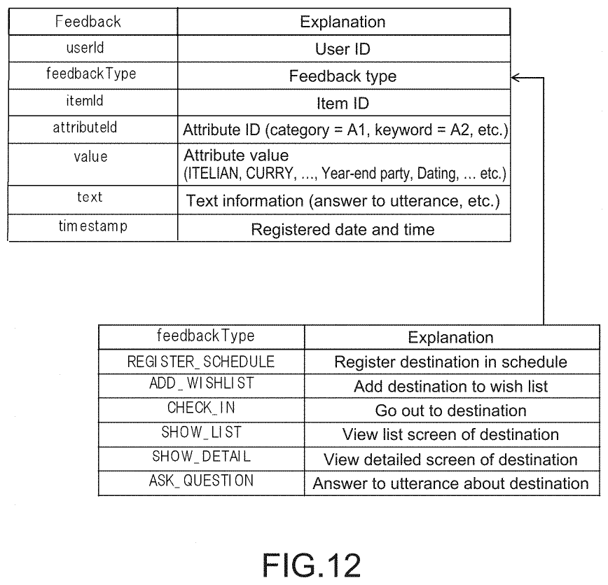

The recommendation unit 260 generates the recommendation result of the content by matching a user preference, which is the user preference information obtained by analyzing a user behavior history included in the user history managed by the user history management unit 270, with the content profile described above. Here, the user preference which is the user preference information is generated from the metadata of the content or a weighted sum of the content profile corresponding to an item ID of an operation target described in the user history (FIG. 12). As a method of matching the user preference and the content profile, for example, there is a method of calculating an inner product for each item between the user preference and the content profile and calculating a sum of the inner products as a recommendation score (for example, Japanese Patent Laid-Open No. 2005-176404). In this method, the content of the content profile having a higher recommendation score is used as the recommendation result.

In order to generate the recommendation result for each recommendation condition, the recommendation unit 260 generates a plurality of combinations of the conditions from the user history, assuming that there are, for example, a season (spring, summer, autumn, winter), a period (day return, overnight, two or more nights), and a purpose (family travel, eating out with couple, eating out with family, and going out with family) as candidates for the condition. For example, a first combination such as “season: spring”, “period: day return”, “purpose: eating out with family”, a second combination such as “season: summer”, “period: two or more nights”, and “purpose: family travel”, and a third combination such as “season: winter”, “period: day return”, and “purpose: going out with family” are generated.

The recommendation unit 260 generates, for example, the following recommendation results for each combination.

The first combination,
1^{st} place: baked meat restaurant ABC
2^{nd} place: Japanese food restaurant ABC
3^{rd} place: Italian ABC
   Second combination
1^{st} place: ABC hotel
2^{nd} place: ABC inn
3^{rd} place: ABC amusement park
   Third combination
1^{st} place: ABC concert
2^{nd} place: ABC aquarium
3^{rd} place: ABC museum

When the recommendation result for each combination is generated in this manner, the recommendation unit 260 may set a predetermined filter such that the recommendation result does not include a spot that has already been visited by the user.

The recommendation unit 260 may generate the recommendation result for a user group (family, friend group, etc.) based on a plurality of the user preferences.

Furthermore, the recommendation unit 260 can retrieve the information (content) that matches the condition specified by the user through the voice interaction and present it to the user. At this time, the recommendation unit 260 performs switching between the “proposal mode” and the “question mode” based on the above-mentioned condition rarity, the degree of the interaction progress, or the user reaction clarity. When the “proposal mode” is set, the user is presented with at least one of the information satisfying the condition specified by the user through the voice interaction and the above-mentioned recommendation result. When the “question mode” is set, the recommendation unit 260 generates a question for making the user specify a new condition for retrieval, and performs control so as to present to the user.

(User History Management Unit 270)

The user history management unit 270 accumulates and manages a user behavior with respect to the content on the Internet accessed by the user of the information processing terminal 10 as the user history together with information such as the user reaction obtained by the reaction analysis unit 280 and the user situation obtained by the situation analysis unit 290.

FIG. 12 shows an example of a data structure of the user reaction (feedback) that is the user history. As shown in FIG. 12, a user reaction (feedback) as the user history includes a user ID, a feedback type (feedbackType) indicating a type of the user reaction, an ID of the target content, an ID that identifies a category attribute of the target content, an attribute value, a text such as user speech content being viewed, and a registration date and time. The feedback types (feedbackType) indicating the type of the user reaction include registration in a destination schedule, addition to a destination wish list, an actual departure to the destination, viewing of a list of registered destinations for the spot, viewing of a detailed view of registered destinations for the spot, and answering by the user with respect to the utterance of the voice interactions.

(Reaction Analysis Unit 280)

The reaction analysis unit 280 analyzes the user reaction at the time of browsing the content on the Internet, at the time of registering and browsing the schedule, at the time of the voice interaction, and the like, based on the various types of detection data acquired from the information processing terminal 10. In order to analyze the user reaction, the reaction analysis unit 280 includes, for example, a function of recognizing the direction of the face and the facial expression of the user captured by the camera of the information processing terminal 10, a function of analyzing the content of the user utterance obtained by the microphone of the information processing terminal 10, a function of analyzing the content (sentence) of the text input by the user, a function of analyzing a pulse (number, waveform), a blood pressure, and the like by a biological reaction measuring device, and the like.

(Situation Analysis Unit 290)

Based on the various detection data acquired from the information processing terminal 10, the situation analysis unit 290 analyzes the situation of the user at the time of browsing the content on the Internet, at the time of registering and browsing the schedule, and at the time of the voice interaction. In order to analyze the situation of the user, the situation analysis unit 290 includes, for example, a function of determining the presence/absence of the user from an image or the like captured by the camera of the information processing terminal 10, a GPS reception function of acquiring position information of the information processing terminal 10.

(Information Integration Unit 300)

The information integrating unit 300 controls transfer of information between the respective units and the information communication with the information processing terminal 10. For example, the information integration unit 300 outputs the metadata collected by the information collection unit 240 to the information analysis unit 250, and outputs the information (content profile) analyzed by the information analysis unit 250 to the recommendation unit 260. In addition, the information integration unit 300 outputs the user history managed by the user history management unit 270 to the recommendation unit 260. Furthermore, the information integration unit 300 outputs the user reaction obtained by the reaction analysis unit 280 and the user situation obtained by the situation analysis unit 290 to the recommendation unit 260.

[1-6. Processing from Metadata Analysis to Recommendation Result Determination]

Next, an example of a process flow of metadata analysis according to the present embodiment to determination of a recommendation result will be described.

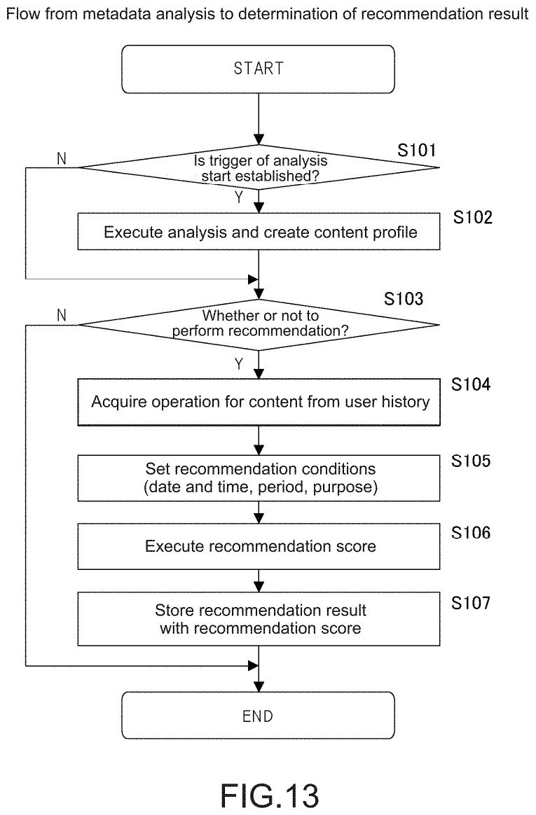

FIG. 13 is a flowchart showing the process flow from the metadata analysis to determination of a recommendation result by the information processing server 20.

The flow is started by, for example, the following trigger.

1. Periodically, e.g., once a day, once an hour, etc.

2. When an update occurs to the collected metadata.

3. When n or more user reaction histories (feedbacks) have been added.

Two or more of these 1 to 3 triggers may be combined.

When determining that the trigger is established (Y in Step S101), the information analysis unit 250 starts analyzing the metadata of the content collected by the information collection unit 240, and creates a content profile (Step S102).

Next, the recommendation unit 260 determines whether or not to execute recommendation (Step S103). This determination is based on two parameters: the interaction progress and the user reaction clarity, when executing the proposed mode described later. This operation will be described in detail later. When the recommendation unit 260 determines that the recommendation is not to be performed (No in Step S103), the presentation control unit 230 ends the process.

When it is determined that the recommendation is to be executed (Yes in Step S103), the recommendation unit 260 acquires the user history from the user history management unit 270 (Step S104). At this time, the recommendation unit 260 acquires the content profile corresponding to the item ID of the target spot of the user history having the predetermined feedback type, and generates the user preference which is the user preference information based on the content profile. In this case, a plurality of feedback types may be selected, or the user preference may be generated by weighting for each feedback type.

Next, the recommendation unit 260 sets the recommendation condition (Step S105). The recommendation conditions include, for example, the date and time, the period, the purpose, and the like, as described above. Next, the recommendation unit 260 calculates the recommendation score based on the set recommendation condition (Step S106), and stores the calculated recommendation score and the recommendation result in the storage unit 220 (FIG. 4) (Step S107).

(Specific Examples of Calculation of Recommendation Score)

Next, the calculation of the recommendation score will be described with reference to specific examples.

In Step S102, the information analysis unit 250 generates the content profile as described below.

Spot A:

{Hot spring=1.0, Kusatsu=1.0Open-air bath=0.6, Viking=0.4, Massage=0.2} [Latitude=xxx, Longitude=xxx, Popularity=4.1, Adult price=15,000 yen, Child price=10,000 yen]

Spot B:

{Theme Park=1.0, Fuji=1.0, Safari=0.8, Trial=0.5, Bus=0.3} [Latitude=xxx, Longitude=xxx, Popular=4.4, Adult price=27,000, Child price=1,500 yen]

Spot C:

{Camp field=1.0, Tanzawa=1.0, Dog run=0.7, Cottage=0.5, Pan=0.4,}[Latitude=xxx, Longitude=xxx, Popularity=3.6, Price=4,000 yen]

In addition, the recommendation unit 260 acquires the user history as described below in Step S104. Here, as a feedback type, an operation history for a spot for which schedule registration has been performed is acquired.

2015/05 “Family travel”->overnight, Spot X: {Hot spring=1.0, Atami=1.0, Open-air bath=0.6, Italian=0.4, Esthetic=0.1} [Latitude=xxx, Longitude=xxx, Popularity=3.8, Adult price=12,000 yen, Child price=8,000 yen]

2016/05 “Travel with family”->overnight, Spot Y: {Hot spring=1.0, Nasu Highlands=1.0, Cottage=0.5, Japanese food=0.3, Massage=0.2} [Latitude=xxx, Longitude=xxx, Popular=4.2, Adult price=16,000 yen, Child price=10,000 yen]

2016/11, “Parent and child go out”->overnight,

Spot Z:

{Camp Field=1.0, Minamiboso=1.0, Fishing=0.7, Tent=0.3, Hiking=0.2} [Latitude=xxx, Longitude=xxx, Popularity=3.7, Price=5,000 yen]

In addition, the recommendation unit 260 sets a recommendation condition as described below in Step S105.

Date and time: 2017/05/01 =[Spring], period [Overnight], purpose [travel with family]

Next, in Step S106, the recommendation unit 260 calculates the recommendation score as described below. The UP below indicates the user preference.

UP [Spring]=Spot X+Spot Y:

{Hot spring=2.0, Atami=1.0, Nasu Highlands=1.0, Open-air bath=0.6, Italian=0.4, Esthetic=0.1, Cottage=0.5, Japanese food=0.3, Massage=0.2}

Vector cos operation between UP [Spring] and Spots A, B, and C:

UP-A: {1.0*2.0 (Hot springs)+0.6*0.6 (Open-air bath)+0.2*0.2 (Massaging)}/{{square root (2.0²+1.0²+1.0²+0.6²+0.4²+0.1²+0.5²+0.3²+0.2²)(UP norm)*{square root (1.0²+1.0²+0.6²+0.4²+0.2²) (A norm)}}=2.4/{square root (6.91*{square root(2.56)})}=0.570
UP-B: 0.00 (No common metadata)
UP-C: {0.5*0.5 (Cottage)/{square root (2.0²+1.0²+1.0²+0.6²+0.4²+0.1²+0.5²+0.3²+0.2²) (UP norm)*square root (1.0²+1.0²+0.7²+0.5²+0.4²)(C norm)}=0.25/{square root 6.91*square root 2.9}=0.055

UP [Overnight]=Spot X+Spot Y+Spot Z:

{Hot spring=2.0, Camp field=1.0, Atami=1.0, Nasu Highlands=1.0, Minamiboso=1.0, Open-air bath=0.6, Italian=0.4, Esthetic=0.1, Cottage=0.5, Japanese food=0.3, Massage=0.2, Fishing=0.7, Tent=0.3, Hiking=0.2}

Vector cos operation between UP [Overnight] and Spots A, B, and C:

UP-A: {1.0*2.0 (Hot spring)+0.6*0.6 (Open-air bath)+0.2*0.2 (Massage)}/{{square root (2.0²+1.0²+1.0²+1.0²+1.0²+0.6²+0.4²+0.1²+0.5v+0.3²+0.2²+0.7²+0.3²+0.2²) (UP norm)*{square root (1.0²+1.0²+0.6²+0.4²+0.2²)(A norm)}}=2.4/{square root (9.53*{square root(2.56)})}=0.485
UP-B: 0.00 (no common metadata)
UP-C: {1.0*1.0 (Camp field)+0.5*0.5 (Cottage)/{square root (2.0²+1.0²+1.0²+1.0²+1.0²+0.6²+0.4²+0.1²+0.5²+0.3²+0.2²+0.7²+0.3²+0.2²) (UP norm)*square root (1.0²+1.0²+0.7²+0.5²+0.4²) (C norm)}=1.25/{square root 9.53*square root 2.9}=0.237

UP [Family travel]=Spot X+Spot Y:

{Hot spring=2.0, Atami=1.0, Nasu Highlands=1.0, Open-air bath=0.6, Italian=0.4, Esthetic=0.1, Cottage=0.5, Japanese food=0.3, Massage=0.2}

Vector cos operation between UP [Spring] and Spots A, B, and C:

UP-A: {1.0*2.0 (Hot springs)+0.6*0.6 (Open-air bath)+0.2*0.2 (Massage)}/{{square root (2.0²+1.0²+1.0²+0.6²+0.4²+0.1²+0.5²+0.3²+0.2²) (UP norm)*{square root (1.0²+1.0²+0.6²+0.4²+0.2²)(A norm)}}=2.4/{square root (6.91*{square root (2.56)})}=0.570
UP-B: 0.00 (no common metadata)
UP-C: {0.5*0.5 (cottage)/{square root (2.0²+1.0²+1.0²+0.6²+0.4²+0.1²+0.5²+0.3²+0.2²) (UP norm)*square root (1.0²+1.0²+0.7²+0.5²+0.4²) (C norm)}=0.25/{square root 6.91*square root 2.9}=0.055

Through the above calculation, the following recommendation score is calculated.

UP-A [Comprehensive]=UP-A [Spring]+UP-A [Overnight]+UP-A [Family travel]=0.570+0.485+0.570=1.625

UP-B [Comprehensive]=UP-B [Spring]+UP-B [Overnight]+UP-B [Family travel]=0.000+0.000+0.000=0.000

UP-C [Overall]=UP-C [Spring]+UP-C [Overnight]+UP-C [Family Travel]=0.055+0.237+0.055=0.347

The recommendation unit 260 may narrow down the target spot based on the calculated recommendation score. The recommendation unit 260 can perform conditional filtering such as excluding, for example, those with popularity=less than 3.5 from the recommendation result.

The user according to the present embodiment may include both a user individual and a user group to which the user belongs.

For example, if the user individual is a wife at home, it is assumed that there is a difference between the information that the user individual wants for herself and the information that she wants for the user group or family. Therefore, the recommendation unit 260 according to the present embodiment may calculate the recommendation score for either the user individual or the user group to determine a recommendation spot.

The details of the process from the metadata analysis to the determination of the recommendation result.

[1-5. Retrieval by Voice Interaction]

Next, the content retrieval by the voice interaction according to the present embodiment will be described.

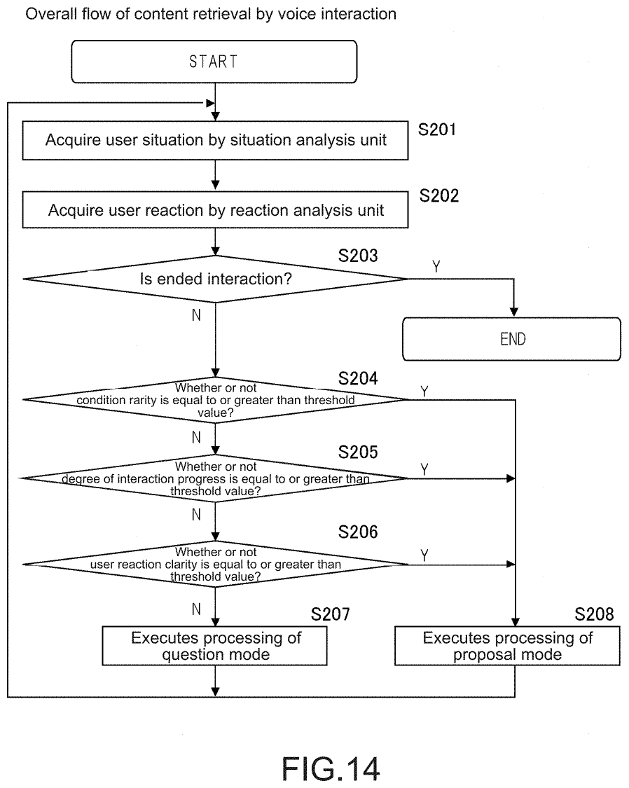

FIG. 14 is a flowchart showing an overall flow of the content retrieval by the voice interaction.

First, when presence of the user in front of the information processing terminal 10 is detected by a human sensor such as a camera, an infrared sensor, or an ultrasonic sensor, or when the user makes a predetermined utterance toward the information processing terminal 10, the content retrieval by the voice interaction is started.

When the content retrieval by the voice interaction is started, the situation analysis unit 290 analyzes the user situation (whether or not user exists in voice interaction environment, direction of the user's face, etc.). A user situation analysis result acquired by the situation analysis unit 290 is supplied to the recommendation unit 260 by the information integration unit 300 (Step S201).

Furthermore, the reaction analysis unit 280 analyzes the user reaction in the voice interaction, and the result of the analysis is supplied to the recommendation unit 260 by the information integration unit 300 (Step S202).

Then, it is determined whether or not a condition for ending voice interaction is established (Step S203). Determination of the establishment of the ending condition of the voice interaction will be described later.

When the ending condition of the voice interaction is not established (N in Step S203), the recommendation unit 260 calculates the condition rarity, and determines whether or not the calculated condition rarity is equal to or greater than a threshold value for evaluating the condition rarity (Step S204). Details of the condition rarity and the calculation method thereof will be described later.

When the condition rarity is equal to or greater than the threshold value for evaluating the condition rarity (Y in Step S204), the recommendation unit 260 determines the spot to be proposed to the user in accordance with the flow of the proposal mode, and presents the result to the user of the information processing terminal 10 (Step S208). Details of the question mode process will be described later. When the condition rarity is not equal to or greater than the threshold value for the condition rarity evaluation (N in Step S204), the recommendation unit 260 then calculates the degree of the interaction progress, and determines whether or not the result is equal to or greater than the threshold value for the evaluation of the degree of the interaction progress (Step S205).

When the degree of the interaction progress is equal to or greater than the threshold value for evaluating the degree of the interaction progress (Y in Step S205), the recommendation unit 260 shifts to the process of the proposal mode in the same manner as described above (Step S208). When the degree of the interaction progress is not equal to or greater than the threshold value for evaluating the degree of the interaction progress (N in Step S205), the recommendation unit 260 calculates the user reaction clarity, and determines whether or not the result is equal to or greater than the threshold value for evaluating the user reaction clarity (Step S206).

When the user reaction clarity is equal to or greater than the threshold value for evaluating the user reaction clarity (Y in Step S206), the recommendation unit 260 shifts to the process of the proposal mode (Step S208) in the same manner as described above. When the user reaction clarity is not equal to or greater than the threshold value for evaluating the user reaction clarity (N in Step S206), the recommendation unit 260 executes the question mode process (Step S207).

In the above flow, the order of the evaluation of the condition rarity in Step S204, the evaluation of the degree of the interaction progress in Step S205, and the evaluation of the degree of the user reaction clarity in Step S206 is not limited to this. These three evaluations may be performed in any order. For example, the order of the evaluation of condition rarity, the evaluation of the user reaction clarity, the evaluation of the interaction progress, or the order of the evaluation of interaction progress, the evaluation of user reaction clarity, and the evaluation of the condition rarity, or the order of the evaluation of the interaction progress, the evaluation of the condition rarity, and the evaluation of the user reaction clarity, or the order of the user reaction clarity, the evaluation of condition rarity, and the evaluation of the interaction progress, or the order of the evaluation of user reaction clarity, the evaluation of the interaction progress, and the evaluation of the condition rarity.

(End Condition of Sound Interaction)

Next, an end condition of the voice interaction in Step S203 will be described.

Different conditions are set for the end condition of the voice interaction for each of the user situation and the user reaction. As the end condition of the user situation, for example, there is a method of detecting the user situation based on the user situation such that the user is not detected by the situation analysis unit 290 continuously for a predetermined time or longer. Furthermore, as the end condition of the user reaction, there is a method of detecting the user reaction based on, for example, that the user utterance is not detected by the reaction analysis unit 280 continuously for a predetermined time or longer even if the user is detected by a face recognition. For example, the recommendation unit 260 determines that at least one of the end conditions is established, as the end condition of the voice interaction is established.

Note that the end condition of the voice interaction is not limited to the above, and, for example, the end condition of the voice interaction may be that there is no change in the user situation from a photographed image of the camera, the voice, or the like continuously for a predetermined time or longer.

(Calculation and Evaluation Method of Conditional Rarity)

The condition rarity is an index value for evaluating whether or not narrow down of the retrieval result is sufficient in the content retrieval. The condition rarity is obtained and evaluated, for example, as follows:

If a total number of content to be retrieved (total number of information) refers to total, the number of content that is hit the condition specified by the user refers to hit, and the condition rarity refers to rarity,

When hit=0, rarity=0,

When hit>0, rarity=1−hit/total.

Specifically, when total is “10,000” and the threshold value of rarity is “0.99”, the condition rarity is equal to or more than the threshold value in a case where hit is less than “1.00”, and the condition rarity is less than the threshold value in a case where hit is equal to or more than “1.00”.

Note that the above-described calculation and evaluation method of the condition rarity is an example, and various modifications are possible.

(Calculation and Evaluation Method of Interaction Progress)

The interaction progress is an index of the number of times and temporal cost of interactions between the system and the user in the voice interactions, and is obtained and evaluated, for example, by the following calculations.

When the number of times the system questions or presents refers to show, and when the number of times the user answers refers to reaction, the number of times of interactions (progress_turn) is calculated by the following equation.

progress_turn=show*0.5+reaction*0.5 (1)

In addition, the norm of the number of times of interactions (progress_turn_norm) is:

When progress_turn>1.0, it is given as 1.0, and

when progress_turn<=1.0, it is given as progress_turn/1.00.

Also, if the interaction time (min) is progress_time, the norm (progress_time_norm) is:

When progress_time>1.0, it is given as 1.0, and when progress_time<=1.0,it is given as progress_time/1.00.

The degree of interaction progress (progress) is calculated by the following equation (2):

progress=(progress_turn_norm+progress_time_norm/2.0 (2)

For a threshold value of progress, 0.8 is used, for example.

The above-described calculation and evaluation method of the degree of the interaction progress is an example, and various modifications are possible. For example, an index value obtained from at least one of the number of interactions and the time may be used as the degree of the interaction progress.

(Calculation and Evaluation Method of User Rection Clarity)

The user reaction clarity is an index indicating the clarity of the user reaction estimated from the state of the user when the user answers (responds) in the voice interaction and the content of the answer (sentence), and is obtained and evaluated by, for example, the following calculation.

For example, the user reaction clarity (clarity) is calculated by the following equation (3).

clarity=Σ{(clarity_face+clarity_speech)/2}/number of answers (3)

Here, clarity_face represents the degree of the user's face directed to the information processing terminal 10, and is given in the range from 0.0 to 1.0 per answer. For example, if the user's face is completely directed to the information processing terminal 10, clarity_face=1.0, and if the user's face is directed to about half, clarity_face=0.5, and if the user's face is almost not directed thereto, clarity_face=0.0.

The clarity_speech is a value given in the range from 0.0 to 1.0 depending on the degree of clarity of the utterance content. For example, clarity_speech=1.0 for statements with clear meanings such as “Yes”, “No”, “Good”, and “XX is not needed”, clarity_speech=0.5 for ambiguous statements such as “Either” and “Not know”, and clarity_speech=0.0 for statements with unknown meanings such as “Let me see”.

For example, 0.2 is used as the threshold value of the user reaction clarity.

Note that the above-described calculation and evaluation method of the user reaction clarity is only an example, and various modifications are possible.

[1-7. Flow of Question Mode Process]

Next, a flow of the question mode process will be described.

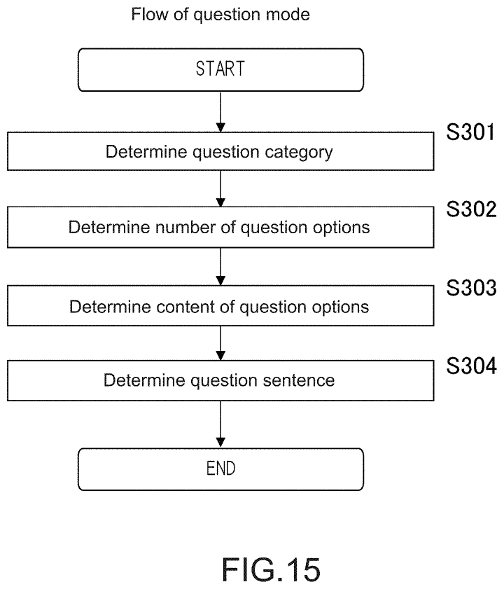

FIG. 15 is a flowchart in the question mode process.

The recommendation unit 260 sequentially executes a process of determining the question category in the option mode question (Step S301), a process of determining the number of question options (Step S302), a process of determining the content of the question options (Step S303), and a process of determining a question sentence (Step S304). Details for each process will be described below.

(Determination of Question Category)

First, details of the process of determining the question category in Step 301 will be described.

The recommendation unit 260 probabilistically selects the question category to be used for the option mode question among a plurality of question categories for classifying types of question categories corresponding to a priority determined among the plurality of question categories.

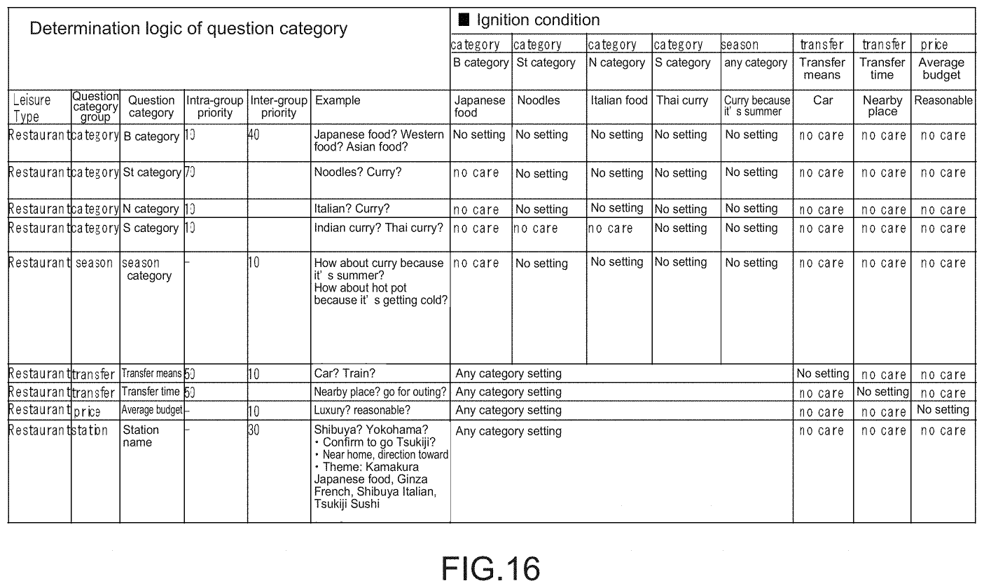

FIG. 16 is a diagram showing examples of a rule for determining the question category.

FIG. 16 shows the rule used to determine the question category for the content retrieval relating to restaurants.

The question category includes bloadcategory (B category), stylecategory (St category), nudgecategory (N category), and servicecategory (S category), as well as seasoncategory, transfer means and transfer time, a budget, a station name, and so on. The above question categories are grouped into a category group of the bloadcategory (B category), the stylecategory (St category), the nudgecategory (N category), and the servicecategory (S category), into a season group of seasoncategory, into a transfer group of the transfer means and transfer time, into a price group of the budget, and into a station group of the station name.

Each question category has an inter-group priority and an intra-group priority. The inter-group priority is a selection priority among the question category groups, and the intra-group priority is a selection priority among each question category within the question category group.

The inter-group priority is given by a value distributed among each group at a constant rate, with a total value of the selection priorities assigned to all the question category groups as “100”. In FIG. 16, “40” is assigned to the category group, “10” is assigned to the season group, “10” is assigned to the transfer group, “10” is assigned to the price group, and “30” is assigned to the station group.

Similarly, the intra-group priority is given by a value distributed among all the question categories belonging to the same group, with a total value of the selection priorities assigned to all the question categories belonging to the same group is set to “100”.

In FIG. 16, the “ignition condition” is a necessary condition for making each question category a selection candidate according to the priority. For example, the ignition condition for the B category to be the selection candidate according to the priority is that the answer from the user is not completed for the question of any question category of the B category, the St category, the N category, the S category, or the seasoncategory in the voice interaction up to that point. Furthermore, the ignition condition for the St category to be the selection candidate according to the priority is that the answer from the user is not completed for the question of any of the question categories of the St category, the N category, the S category or the seasoncategory in the voice interaction up to that point.

Next, examples of determining the question category based on the rule of FIG. 16 will be described.

Now, in the voice interaction, it considers the situation that only the answer from the user to the question of the question category in the B category is completed. In this instance, the question categories satisfying the ignition condition are the St category, the N category, the S category, the seasoncategory question categories as well as the question categories of transfer means/transfer time, the budget, and the station name.

Next, referring to the inter-group priority of each question category group to which each question category belongs from the rule shown in FIG. 16, category=40, season=10, transfer=10, price=10, and station=30.

Next, the recommendation unit 260 selects a question category group by a roulette selection.

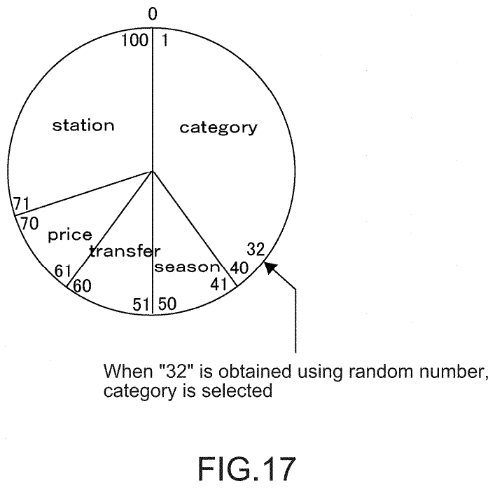

FIG. 17 is a diagram for explaining a roulette selection method of the question category group. Here, the roulette is set with a target corresponding to the total value of the inter-group priority of all the question category groups. That is, since the sum of the inter-group priorities of all question category groups is “100”, the category group is assigned to the range from “1” to “40”, the season group is assigned to the range from “41” to “50”, the transfer group is assigned to the range from “51” to “60”, the price group is assigned to the range from “61” to “70”, and the station group is assigned to the range from “71” to “100”, respectively, in the roulette in which the numeric values “1” to “100” are set. Next, the recommendation unit 260 calculates one numerical value between “1” and “100” using a random number, and sets the question category of the numerical value range to which this numerical value belongs as a selection result. For example, when the numerical value of “32” is obtained using the random number, the category group is obtained as the selection result of the question category group.

Next, the recommendation unit 260 again selects the question category by the roulette selection from among the question categories other than the B category (St category, N category, S category) belonging to category group. Referring to the rule of FIG. 16, the intra-group priorities of the St category, the N category, and the S category are: St category=70, N category=10, and S category=10. Therefore, the recommendation unit 260 assigns the St category to the range from “1” to “70”, the N category to the range from “71” to “80”, and the S category to the range from “81” to “90”, respectively, in the roulette in which the numerical values from “1” to “90” are set. Next, the recommendation unit 260 determines one numerical value between “1” and “90” using the random number, and sets the question category of the range to which this numerical value belongs as the selection result. For example, when a numerical value of “58” is obtained using the random number, the question category of the St category is obtained as the selection result.

As a result, the St category is finally determined as the question category.

(Determination of Number of Question Options)

Next, the details of the process of determining the number of question options in Step 302 of FIG. 15 will be described.

The number of question options is the number of options in the option mode question, e.g. “Which of A, B, C do you like?”, in this case, the number is “3”. The recommendation unit 260 probabilistically selects the number of options in the option mode question according to the priority determined corresponding to the number of answers from the user by the voice interaction.

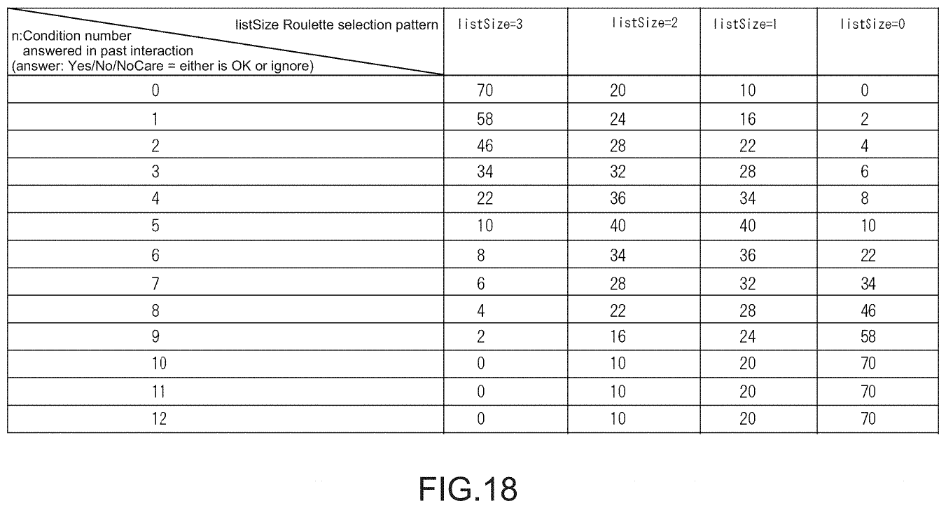

FIG. 18 is a diagram showing an example of a rule for determining the number of question options.

In a determination rule of the number of question options, the number of question options (listSize) is decided from the number of answers (n) and a roulette selection pattern by the user in the past voice interaction. The roulette selection pattern is provided for each candidate of the number of question options. In the present embodiment, there are the roulette selection pattern corresponding to listSize=3, the roulette selection pattern corresponding to listSize=2, the roulette selection pattern corresponding to listSize=1, and the roulette selection pattern corresponding to listSize=0. To each roulette selection pattern, a selection probability for the value of the number of answers (n) is assigned. For example, for n=1, “58” is registered in the roulette selection pattern corresponding to listSize=3, “24” is registered in the roulette selection pattern corresponding to listSize=2, “16” is registered in the roulette selection pattern corresponding to listSize=1, and “2” is registered in the roulette selection pattern corresponding to listSize=0. This means that listSize=3 is assigned to the range from “1” to “58”, listSize=2 is assigned to the range from “59” to “83”, listSize=1 is assigned to the range from “84” to “98”, and listSize=0 is assigned to the range from “99” to “100”, respectively, in the roulette in which the numeric values “1” to “100” are set.

The recommendation unit 260 determines listSize to which the numerical value calculated using the random number belongs as the selection result of the number of question options in the numerical value range from “1” to “100”. For example, when the numerical value calculated using the random number is “64”, the recommendation unit 260 determines “listSize=2” as the selection result of the number of question options.

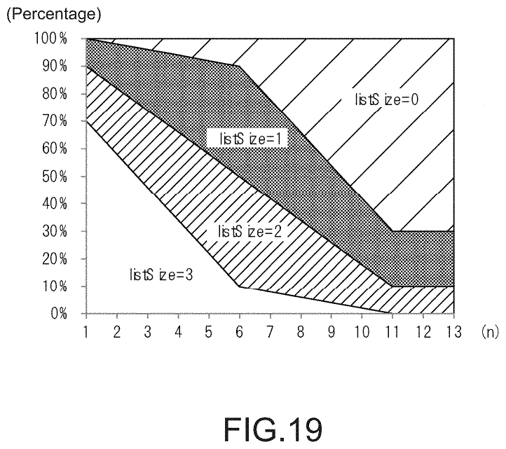

FIG. 19 is a graph showing selection probabilities distributions for the values of the answers (n) among the respective roulette selection patterns of listSize=3, 2, 1, 0. As shown in the graph, as the number of answers (n) increases, the selection probability of the roulette selection pattern having a smaller number of question options increases, whereby it is possible to probabilistically avoid the user from being presented with an excessive number of question options totally, and it is possible to expect a burden reduction of the user.

Note that various modifications are conceivable for the rule for determining the number of question options. For example, the number of question options in which the number of answers (n) from the user is large or in which the user reaction clarity is high, or the number of question options in which the number of answers from the user “Yes” is large may be preferentially selected.

(Determination of Content of Question Options)

Next, the details of the process for determining the content of the question options in Step 303 of FIG. 15 will be described.

The recommendation unit 260 probabilistically selects the question category to be used for the option mode question among the plurality of question categories for classifying the types of question categories corresponding to the priority determined among the plurality of question categories.

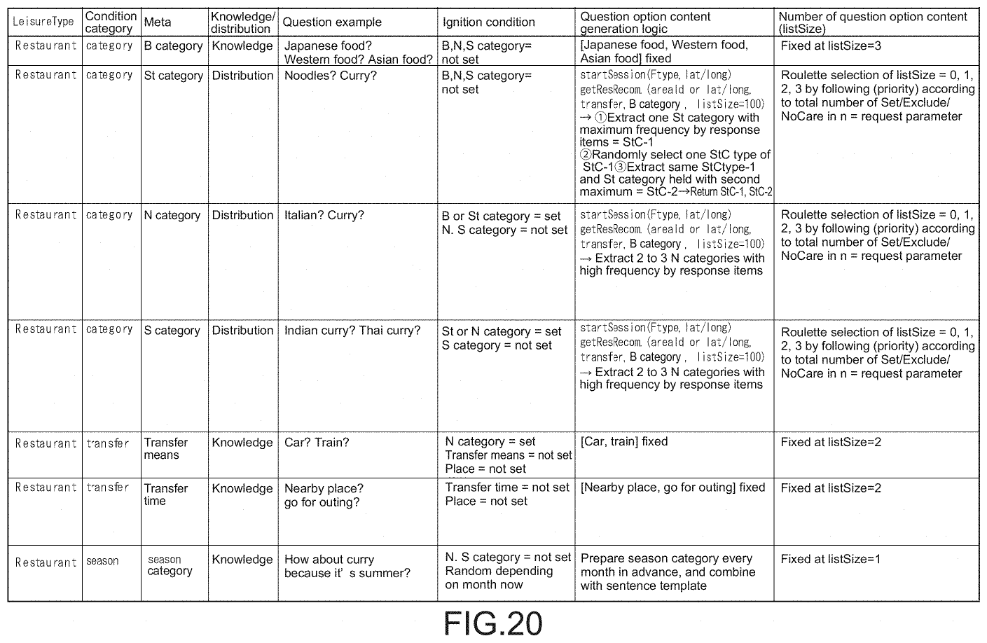

FIG. 20 is a diagram showing a part of a rule for determining the content of the question options.

In the determination rule of the content of the question options, it is determined whether “knowledge” or “distribution” is used in determination of the content of the question options for each condition category. Here, “knowledge” is fixed content of the question options, and “distribution” means generating the content of the question options from a group of categories ranked based on a specific condition such as a frequency of use of answers by the user in general and a popularity order. A specific determination method of the content of the question options based on the “knowledge” or a specific determination method of the content of the question options based on the “distribution” are determined as a generation logic of the content of the question options of the rule shown in FIG. 20. For example, the content of the question options for the question categories of the B category is generated based on the knowledge that “Japanese food, Western food, or Asian food” is used in a fixed manner. Also, the content of the question options of the St category is generated based on a generation logic of the content of the question options of extracting the top n St categories ranked based on, for example, answer selection frequencies of all users among St categories that can go within one hour from a user's home. For example, when the question category of the St category is determined in Step S301 of FIG. 15 and the number of question options is determined to be “2” in Step S302 of FIG. 15, the St categories of the first and second ranks in popular order are determined as the content of the question options. For example, it is determined as follows: 1^{st} place is “Pork cutlet”, 2^{nd} place is “Tempura” (fritter), and so on.

(Determination of Question Sentence)

Next, the details of the process of determining the question sentence in Step 304 will be described.

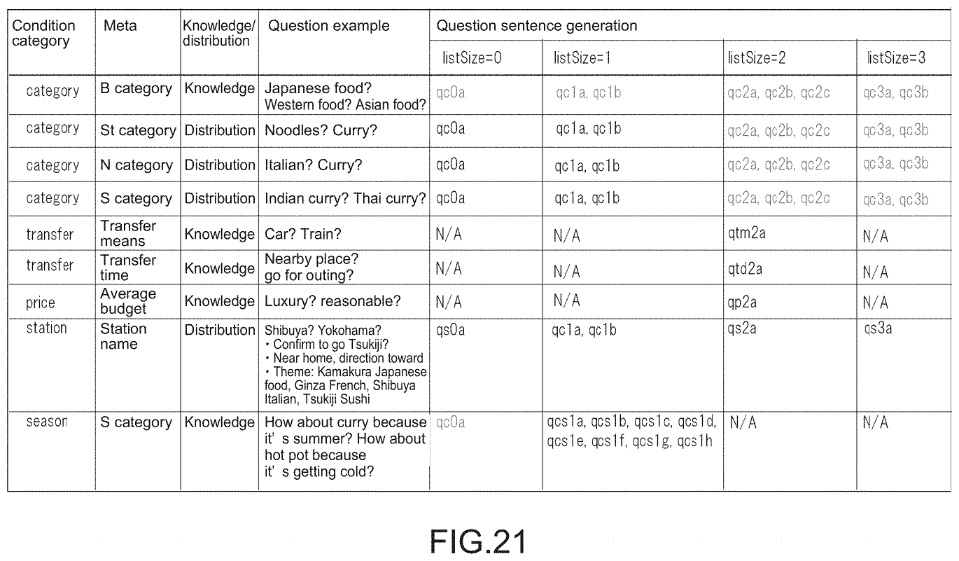

FIG. 21 is a diagram showing a rule for determining the question sentence.

In the rule for determining the question sentence according to the present embodiment, an identification number (question ID) of a template of the question sentences is determined for each combination of the question category and the number of question options (listSize).

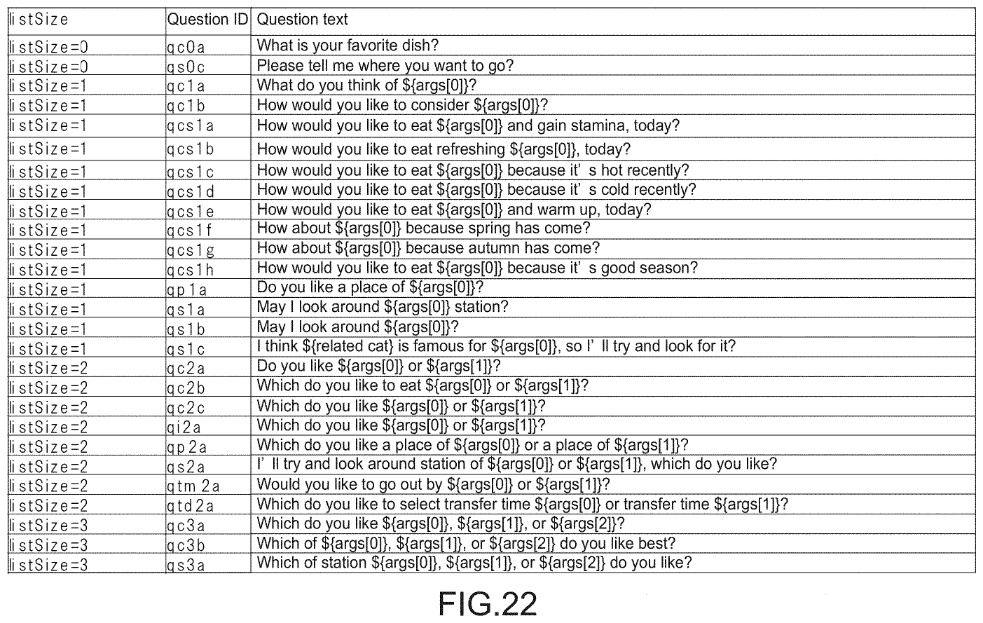

FIG. 22 is a diagram showing an example of a question sentence template table for each question ID. For example, a question sentence template of “What is your favorite dish?” is registered corresponding to the question ID=qc0a, and a question sentence template of “What do you think of ${args[0]}?” is registered corresponding to the question ID=qc1a. Here, ${args[0]} refers to the 1^{st} place category of ranked categories based on the answer selection frequencies of all users, and the like. Similarly, ${args[1]} means the 2^{nd} place category, and ${args[2]} means the 3^{rd} place category.

In the rule for determining the question sentence of FIG. 21, a plurality of question IDs including “qc1a, qc1b” and “qc2a, qc2b, qc2c” registered is randomly selected by the recommendation unit 260 by the roulette selection or the like. For example, since the St category is determined as the question category in Step S301 of FIGS. 15 and “2” is determined as the number of question options (listSize) in Step S302, one question ID is randomly selected from “qc2a, qc2b, qc2c” following the rules of FIG. 21. If “qc2b” is selected, the question sentence template “Which do you like to eat ${args[0]} or ${args[1]}?” is retrieved from the question sentence template table of FIG. 22, and the question sentence “Which do you like to eat pork cutlet or Tempura (fritter)?” is created by combining with the determination result of the content of the question options in Step 303.

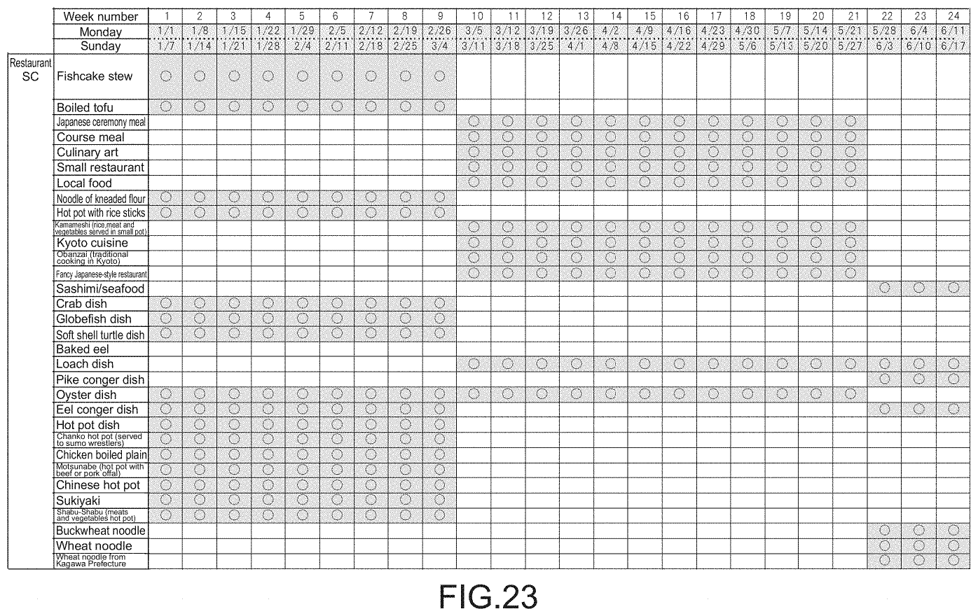

Next, an operation when the seasoncategory is selected by the roulette as the question category in Step S301 of FIG. 15 will be described. In this case, referring to the determination rule of the content of the question options in the seasoncategory from the determination rule of the content of the question options of FIG. 20, it is decided that only one result obtained by, for example, randomly retrieving a current season category from a season category table as shown in, for example, FIG. 23 is set as the content of the question options. Here, assuming that the current date is March 5, a “loach dish” is randomly retrieved from the season category table, for example. On the other hand, according to rule for determining the question sentence of FIG. 21, it is determined that the question ID of the question sentence template to be used for the seasoncategory is one of “qcs1a, qcs1b, qcs1c, qcs1d, qcs1e, qcs1f, qcs1g, qcs1h” which is suitable for the season. If the current season is spring, by combining the “loach dish” retrieved from the season category table with the question sentence template “How about ${args[0]} because spring has come?” corresponding to the question ID “qcs1f”, the question sentence “How about ${args[0]} because spring has come?” is generated.

Here, the case in which the content of the question options is determined by retrieving season content from the season category table based on the date is described, but similarly, an event or the like may be retrieved from an event table based on the date and determined as the content of the question options. In addition, the content of the question options may be determined by retrieving various types of content including advertisement data and the like from not the date but date and time data including time.

The above is the description of the question generation operation.

[1-8. Flow of Proposal Mode Process]

Next, a flow of the proposed mode process started in the voice interaction with the user will be described.

In the proposed mode, the recommendation unit 260 presents at least one of the first information, which is the retrieval result according to the condition acquired through the voice interaction with the user, or the second information, which is recommendation information according to the user preference.

The proposed mode is started in the voice interaction with the user for the content retrieval shown in FIG. 14, for example, when the condition rarity is greater than or equal to the threshold value, when the interaction progress is greater than or equal to the threshold value, or when the user reaction clarity is greater than or equal to the threshold value.

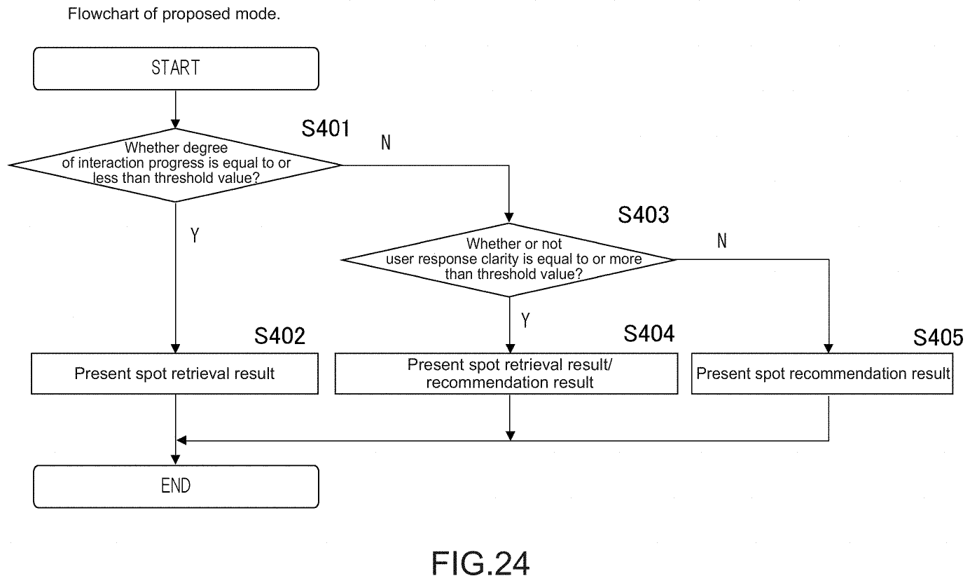

FIG. 24 is a flowchart of the proposed mode process.

In the proposed mode, the recommendation unit 260 determines whether the degree of the interaction progress is equal to or less than threshold value (Step S401). When the degree of the interaction progress is less than or equal to the threshold value for evaluating the degree of the interaction progress, it can be recognized that the user shifts to the question mode because the condition rarity is equal to or greater than the threshold value. In this case, a content retrieval result is presented to the user of the information processing terminal 10 assuming that narrowing down of the content retrieval result by the condition of the spot that matches the condition specified by the user in the voice interaction (for example, the condition including the answer to the question given to the user in the question mode) is sufficient (Step S402).

When the degree of the interaction progress is not equal to or less than the threshold value for evaluating the degree of the interaction progress (N in Step S401), the recommendation unit 260 determines whether or not the user reaction clarity is equal to or more than the threshold value for evaluating the user reaction clarity (Step S403). When the user reaction clarity is not equal to or more than the threshold value for evaluating the user reaction clarity (N in Step S403), there is a high possibility that the condition specified by the user in the voice interaction lacks validity, and therefore, among spot recommendation results generated as in FIG. 13, an upper predetermined number of spot recommendation results with high recommendation scores, that is, spots matching the user preference based on the user history are presented to the user of the information processing terminal 10 (Step S405).

Furthermore, when the degree of the interaction progress is not equal to or less than the threshold value for evaluating the degree of the interaction progress (N in Step S401) and the user reaction clarity is equal to or more than the threshold value for evaluating the user reaction clarity (Y in Step S403), in addition to the retrieval results of the spots that meet the condition specified by the user in the voice interaction (e.g., the condition including the answer to the question given to the user in the question mode), an upper predetermined number of the spot recommendation results with the high recommendation scores are presented to the user of the information processing terminal 10 from the spot recommendation results generated as in FIG. 13 (Step S404).

The threshold value for evaluating the degree of the interaction progress in the flow of FIG. 24 may be the same as or different from the threshold value for evaluating the degree of the interaction progress in the flow of FIG. 14. In addition, the threshold value for evaluating the user reaction clarity in the flow of FIG. 24 may be the same as or different from the threshold value evaluating the user reaction clarity in the flow of FIG. 14.

[1-9. Hardware Configuration Example]

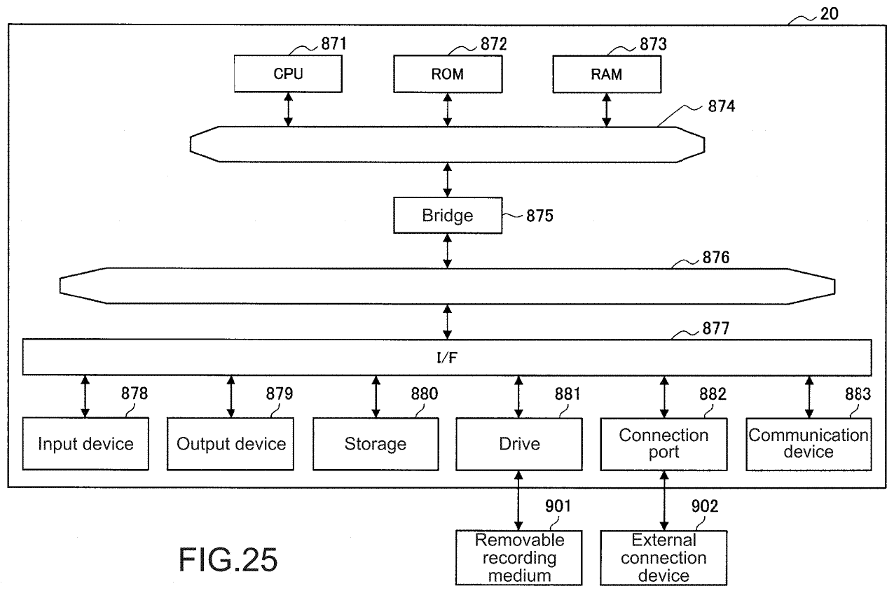

Next, a hardware configuration example common to the information processing terminal 10 and the information processing server 20 according to an embodiment of the present disclosure will be described. FIG. 25 is a block diagram showing an example of the hardware configuration of the information processing terminal 10 and the information processing server 20 according to the embodiment of the present disclosure.

The information processing terminal 10 and the information processing server 20 include, for example, a CPU 871, a ROM 872, a RAM 873, a host bus 874, a bridge 875, an external bus 876, an interface 877, an input device 878, an output device 879, a storage 880, a drive 881, a connection port 882, and a communication device 883. It should be noted that the hardware configuration shown here is an example, and some of the components may be omitted. It may also further include components other than the components shown here.

The CPU 871, for example, functions as an arithmetic process unit or a control unit, and controls overall operations or a portion thereof of the components based on various programs recorded on the ROM 872, the RAM 873, the storage 880, or a removable recording medium 901.

The ROM 872 is a means to store a program to be read into the CPU 871, data to be used in the calculation, and the like. The RAM 873 temporarily or permanently stores, for example, a program to be read into the CPU 871 and various parameters that change appropriately when the program is executed.

The CPU 871, the ROM 872, the RAM 873 are interconnected, for example, through a host bus 874 capable of high-speed data transmission. On the other hand, the host bus 874 is connected to the external bus 876 having a relatively low data transmission speed through the bridge 875, for example. Furthermore, the external bus 876 is connected to various components through the interface 877.

For example, a mouse, a keyboard, a touch panel, a button, a switch, a lever, and the like are used as the input device 878. Furthermore, a remote controller capable of transmitting a control signal using infrared rays and other radio waves may be used as the input device 878. Furthermore, the input device 878 includes a voice input device such as a microphone.

The output device 879 is a device capable of visually or audibly notifying a user of acquired information, for example, a display device such as a cathode ray tube (CRT), an LCD, and an organic EL, an audio output device such as a speaker and a headphone, a printer, a mobile phone, a facsimile, or the like. Furthermore, the output device 879 according to the present disclosure includes various vibration devices capable of outputting tactile stimuli.

The storage 880 is a device for storing various types of data. For example, a magnetic storage device such as a hard disk drive (HDD), a semiconductor storage device, an optical storage device, a magneto-optical storage device, or the like is used as the storage 880.

The drive 881 is, for example, a device that reads information recorded on the removable recording medium 901 such as a magnetic disk, an optical disc, a magneto-optical disk, and a semiconductor memory, or a device that writes information on the removable recording medium 901.

The removable recording medium 901 includes, for example, a DVD medium, the Blu-ray (registered trademark) medium, an HD DVD medium, various semiconductor storage media, or the like. The removable recording medium 901 may be, for example, an IC card on which a contactless IC chip is mounted, an electronic apparatus, or the like as a matter of course.

The connection port 882 is, for example, a port for connecting an external connection device 902 such as a universal serial bus (USB) port, an IEEE1394 port, a small computer system interface (SCSI), an RS-232C port, and an optical audio terminal.

The external connection device 902 may be, for example, a printer, a portable music player, a digital camera, a digital video camera, an IC recorder, or the like.

The communication device 883 is a communication device for connecting to a network and includes, for example, a wired or wireless LAN, the Bluetooth (registered trademark), a communication card for a Wireless USB (WUSB), a router for optical communication, a router for an asymmetric digital subscriber line (ADSL), a modem for various types of communication, and the like.

[1-9. Effects, etc.]

As described above, according to the system or the information processing server 20 of the embodiment of the present technology, when the first process and the second process are timely switched based on the condition rarity, that is, when the condition rarity is low, that is, the narrowing down of the information retrieval result is insufficient, it is possible to explicitly prompt the user to add a new condition by generating the question on the condition for retrieval and presenting it to the user. Also, by presenting the option mode question to the user, the user can quickly respond to the condition with the correct expression. As a result, the burden on the user can be reduced, and the speed and accuracy of information retrieval can be improved. Furthermore, since the question mode and the proposal mode are switched in a timely manner based on the degree of the interaction progress and the user reaction clarity, the information retrieval under a wasteful condition or an unclear condition can be avoided.

The present technology may also have the following structures.

(1) An information processing apparatus, including:

a control unit that switches between a first process of presenting at least one of first information retrieved based on a condition acquired through a voice interaction with a user or second information selected based on a user preference and a second process of generating a question relating to a condition for the retrieval and presenting the question to the user, based on a condition rarity that is an index value relating to a percentage of the number of information matching the condition to a total number of information to be retrieved.

(2) The information processing apparatus according to (1), in which

the second process generates an option mode question.

(3) The information processing apparatus according to (1) or (2), in which

the control unit further switches between the first process and the second process based on a degree of an interaction progress that is an index value relating to at least one of the number of times or the time of the voice interaction.

(4) The information processing apparatus according to any of (1) to (3), in which

the control unit further switches between the first process and the second process based on a user reaction clarity at the time of the voice interaction.

(5) The information processing apparatus according to (4), in which

the control unit determines the user reaction clarity based on a direction of a user's face or utterance content at the time of the voice interaction.

(6) The information processing apparatus according to (4) or (5), in which

the first process selects the information to be presented from the first information and the second information based on the degree of the interaction progress and the user reaction clarity.

(7) The information processing apparatus according to any of (2) to (6), in which

the control unit probabilistically selects a question category to be used for the option mode question among a plurality of question categories for classifying types of question categories corresponding to a priority determined among the plurality of question categories.

(8) The information processing apparatus according to any of (2) to (7), in which

the control unit probabilistically selects the number of options in the option mode question corresponding to the priority determined corresponding to the number of answers from the user by the voice interaction.

(9) The information processing apparatus according to any of (2) to (8), in which

the control unit selects content of an option in the option mode question based on a frequency of use in an utterance or an answer to the question.

(10) The information processing apparatus according to any of (2) to (9), in which

the control unit selects the content of the option in the option mode question based on a date and time condition.

(11) The information processing apparatus according to any of (1) to (9) that is an information processing server or an information processing terminal.
(12) An information processing method, including:

switching by a control unit between a first process of presenting at least one of first information retrieved based on a condition acquired through a voice interaction with a user or second information selected based on a user preference and a second process of generating a question relating to a condition for the retrieval and presenting the question to the user, based on a condition rarity that is an index value relating to a percentage of the number of information matching the condition to a total number of information to be retrieved.

(13) The information processing method according to (12), in which

the second process generates an option mode question.

(14) The information processing method according to (12) or (13), in which

the control unit further switches between the first process and the second process based on a degree of an interaction progress that is an index value relating to at least one of the number of times or the time of the voice interaction.

(15) The information processing apparatus according to any of (12) to (14), in which

the control unit further switches between the first process and the second process based on a user reaction clarity at the time of the voice interaction.

(16) [0 0 0 1] The information processing method according to (15), in which

the control unit determines the user reaction clarity based on a direction of a user's face or utterance content at the time of the voice interaction.

(17) The information processing method according to (15) or (16), in which

the first process selects the information to be presented from the first information and the second information based on the degree of the interaction progress and the user reaction clarity.

(18) The information processing method according to any of (13) to (17), in which

the control unit probabilistically selects a question category to be used for the option mode question among a plurality of question categories for classifying types of question categories corresponding to a priority determined among the plurality of question categories.

(19) The information processing method according to any of (13) to (18), in which

the control unit probabilistically selects the number of options in the option mode question corresponding to the priority determined corresponding to the number of answers from the user by the voice interaction.

(20) The information processing method according to any of (13) to (19), in which

the control unit selects content of an option in the option mode question based on a frequency of use in an utterance or an answer to the question.

(21) The information processing method according to any of (13) to (20), in which

the control unit selects content of an option in the option mode question based on a frequency of use in an utterance or an answer to the question.

(22) A program executed by a control unit that switches between a first process of presenting at least one of first information retrieved based on a condition acquired through a voice interaction with a user or second information selected based on a user preference, and a second process of generating a question relating to a condition for the retrieval and presenting the question to the user, based on a condition rarity that is an index value relating to a percentage of the number of information matching the condition to a total number of information to be retrieved.
(23) The program according to (22), in which

the second process generates an option mode question.

(24) The program according to (22) or (23), in which

the control unit further switches between the first process and the second process based on a degree of an interaction progress that is an index value relating to at least one of the number of times or the time of the voice interaction.

(25) The program according to any of (22) to (24), in which

the control unit further switches between the first process and the second process based on a user reaction clarity at the time of the voice interaction.

(26) The program according to (25), in which the control unit determines the user reaction clarity based on a direction of a user's face or utterance content at the time of the voice interaction.
(27) [0 0 0 2] The program according to (25) or (26), in which

the first process selects the information to be presented from the first information and the second information based on the degree of the interaction progress and the user reaction clarity.

(28) The program according to any of (23) to (27), in which

the control unit probabilistically selects a question category to be used for the option mode question among a plurality of question categories for classifying types of question categories corresponding to a priority determined among the plurality of question categories.

(29) The program according to any of (23) to (28), in which

the control unit probabilistically selects the number of options in the option mode question corresponding to the priority determined corresponding to the number of answers from the user by the voice interaction.

(30) The information processing method according to any of (23) to (29), in which

the control unit selects content of an option in the option mode question based on a frequency of use in an utterance or an answer to the question.

(31) The program according to any of (23) to (30), in which

the control unit selects content of an option in the option mode question based on a frequency of use in an utterance or an answer to the question.

### REFERENCE SIGNS LIST

10 information processing terminal

20 information processing server

30 network

210 terminal communication unit

220 storage unit

230 presentation control unit

240 information collection unit

250 information analysis unit

260 recommendation unit

270 user history management unit

280 reaction analysis unit

290 situation analysis unit

300 information integration unit

1] An information processing apparatus, comprising:
a control unit that switches between a first process of presenting at least one of first information retrieved based on a condition acquired through a voice interaction with a user or second information selected based on a user preference and a second process of generating a question relating to a condition for the retrieval and presenting the question to the user, based on a condition rarity that is an index value relating to a percentage of the number of information matching the condition to a total number of information to be retrieved.

2] The information processing apparatus according to claim 1, wherein
the second process generates an option mode question.

3] The information processing apparatus according to claim 2, wherein
the control unit further switches between the first process and the second process based on a degree of an interaction progress that is an index value relating to at least one of the number of times or the time of the voice interaction.

4] The information processing apparatus according to claim 3, wherein
the control unit further switches between the first process and the second process based on a user reaction clarity at the time of the voice interaction.

5] The information processing apparatus according to claim 4, wherein
the control unit determines the user reaction clarity based on a direction of a user's face or utterance content at the time of the voice interaction.

6] The information processing apparatus according to claim 1, wherein
the first process selects the information to be presented from the first information and the second information based on the degree of the interaction progress and the user reaction clarity.

7] The information processing apparatus according to claim 1, wherein
the control unit probabilistically selects a question category to be used for the option mode question among a plurality of question categories for classifying types of question categories corresponding to a priority determined among the plurality of question categories.

8] The information processing apparatus according to claim 7, wherein
the control unit probabilistically selects the number of options in the option mode question corresponding to the priority determined corresponding to the number of answers from the user by the voice interaction.

9] The information processing apparatus according to claim 8, wherein
the control unit selects content of an option in the option mode question based on a frequency of use in an utterance or an answer to the question.

10] The information processing apparatus according to claim 9, wherein
the control unit selects the content of the option in the option mode question based on a date and time condition.

11] The information processing apparatus according to claim 10 that is an information processing server or an information processing terminal.

12] An information processing method, comprising:
switching by a control unit between a first process of presenting at least one of first information retrieved based on a condition acquired through a voice interaction with a user or second information selected based on a user preference and a second process of generating a question relating to a condition for the retrieval and presenting the question to the user, based on a condition rarity that is an index value relating to a percentage of the number of information matching the condition to a total number of information to be retrieved.

13] A program executed by a control unit that switches between a first process of presenting at least one of first information retrieved based on a condition acquired through a voice interaction with a user or second information selected based on a user preference, and a second process of generating a question relating to a condition for the retrieval and presenting the question to the user, based on a condition rarity that is an index value relating to a percentage of the number of information matching the condition to a total number of information to be retrieved.
